(19) United States
(12) Patent Application Publication
(10) Pub. No.: US 2011/0229106 A1
(43) Pub. Date: Sep. 22, 2011

(54) SYSTEM FOR PLAYBACK OF ULTRA HIGH RESOLUTION VIDEO USING MULTIPLE DISPLAYS

(76) Inventor: HAN-YEOL CHO, Seoul (KR)

(21) Appl. No.: 12/826,356

(22) Filed: Jun. 29, 2010

(30) Foreign Application Priority Data
Mar. 22, 2010 (KR) 10-2010-0025416

(51) Int. Cl. H04N 5/91; H04N 5/935

(52) U.S. Cl. 386/219; 386/E05.001

(57) ABSTRACT

Provided is a system for playback of ultra high resolution video using multiple displays. The system comprises multiple image decoders for decoding each of multiple image files to provide the decoded images to each of multiple displays; management server to provide multiple image files; and relay transmitter to receive the multiple image files from the management server and then distribute the multiple image files to corresponding multiple decoders, wherein the relay transmitter receives display delay time and decoding order for the image files from the management server, and broadcasts the relay time and decoding start order to the multiple image decoders, and each of multiple image decoders decodes corresponding image file in accordance with the decoding start order, respectively, and provides the decoded image to each of multiple displays after delay time.

### CROSS-REFERENCE(S) TO RELATED APPLICATIONS

The present invention claims priority of Korean Patent Application Nos. 10-2010-0025416 filed on Mar. 22, 2010, which are incorporated herein by reference.

### BACKGROUND OF THE INVENTION

1. Field of the Invention

The present invention relates to a multiple display. More particularly, the present invention relates to a method and system for playing back image of ultra high resolution on multiple displays.

2. Description of Related Art

Public electronic displays so far have larger size than conventional TV or monitor, but they have almost the same resolution as conventional TV or monitor has. As consequence, so-called “cascade effect” resulting from large pixel size makes viewers feel that quality of image is not good.

To overcome this effect, it is necessary to increase resolution of image on display.

One of ways to increase resolution is make the size of lighting pixel smaller on the display, thereby providing more numbers of pixels on the same size display. Or using several display devices with matrix arrangement is possible. For example, four 4:3 SD standard display device, of which resolution is 720×480, can be arranged 2×2 formation to display images up to 1440×960 resolution.

Recently, the resolution of HD standard display has reached 1920×1080. Therefore, high resolution images or media can be displayed on large public display.

To playback ultra high resolution image such as 7690×2170 on large size display, conventional display system has decoding system which can decode one ultra high resolution image, and divides the decoded image to output through HD standard displays. In this system, image output card is necessary to divide one image into multiple images displayed on multiple channels, and to synchronize the multiple images. Also, even though the large size image is divided into multiple channels though multiple display devices, the image is still one rectangular image.

### SUMMARY OF THE INVENTION

An object of the present invention is to provide a device to playback standard or non-standard ultra high resolution images using conventional decoding equipment and device.

In one aspect of the present invention, a system for playback of ultra high resolution video using multiple displays according to claim 1 is provided, comprising multiple image decoders for decoding each of multiple image files to provide the decoded images to each of multiple displays; management server to provide multiple image files; and relay transmitter to receive the multiple image files from the management server and then distribute the multiple image files to the multiple decoders.

According to an embodiment of the present invention, the relay transmitter receives delay time and decoding order for the image files from the management server, and broadcasts the relay time and decoding order to the multiple image decoders, and each of multiple image decoders decodes the image files in accordance with the decoding order, respectively, and provides the decoded image to each of multiple displays after delay time is provided.

According to another embodiment of the present invention, the management server sets image decoder as destination which plays back each of image files, and transmit data for multiple image files to the relay transmitter, or transmits image files divided with the time range, frame, picture or data size simultaneously.

According to still another embodiment of the present invention, the image decoder estimates and provides to the management server the time lapse between the decoding order reached and the decoded image output, and the management server determines the delay time based upon the time lapse from the image decoders.

According to still another embodiment of the present invention, the multiple displays are arranged to form m×n (m and n are integers >1) rectangular matrix.

According to still another embodiment of the present invention, multiple displays are arranged in random pattern.

The advantage of the present invention is that images having ultra high resolution can be displayed on multiple displays in efficient manner using conventional devices such as image decoder, display devices.

Also, remote control for playback of multiple images on multiple display devices is possible using remote management server.

### BRIEF DESCRIPTION OF THE DRAWINGS

FIG. 1 is a block diagram illustrates an image playback system on multiple displays according to one embodiment of the present invention.

FIG. 2 is a conceptual drawing for the system of the present invention using multiple display devices arranged in orderly manner.

FIG. 3 is another conceptual drawing for the system of the present invention using multiple display devices arranged in random manner.

### DESCRIPTION OF SPECIFIC EMBODIMENTS

The advantages, features and aspects of the invention will become apparent from the following description of the embodiments with reference to the accompanying drawings, which is set forth hereinafter. Therefore, the present invention is not to be duly limited to the illustrative embodiments and may be embodied in other forms. In the drawings, like reference numerals in the drawings denote like elements. The shape, size and regions, and the like, of the drawing may be exaggerated for clarity.

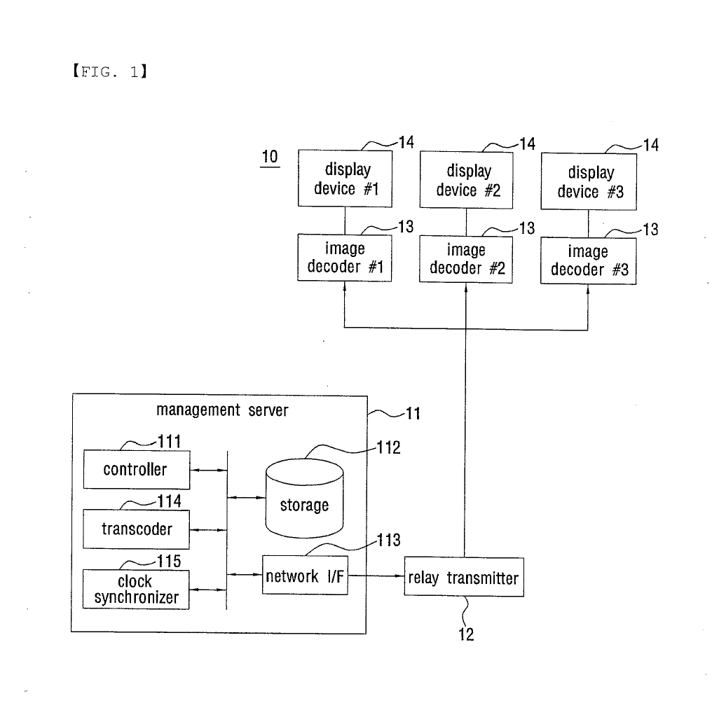

FIG. 1 is a block diagram illustrates an image playback system on multiple displays according to one embodiment of the present invention.

Referring to FIG. 1, the system comprises management server 11, relay transmitter 12, multiple image decoders 13, and multiple displays 14. The function of relay transmitter 12 can be performed by management sever 11 itself, depending upon network environment. Further, displays 14 may comprise image decoder 13 therein.

Management server 11 may comprise server 111, storage 112, and network interface 113, and be ready to transmit multiple image files, each of which is played back by each of image decoders 13. At this time, management server 11 sets image decoders to play back each of image files and transmit multiple image files to the relay transmitter 12 in predetermined order. In another embodiment, the management server 11 may divide the image files with criteria of time-range, frame, picture or data size and transmit the divided files to the relay transmitter 12.

According to one embodiment of the present invention, management server 11 further comprises transcoder 114. When the resolution of display playing back decoded image file is lower than that of the image file, or the transmittance rate is lower than predetermined rate, the management server 14 may use the transcoder 114 to transcode the image file depending upon the display resolution or transmittance rate.

When each of image decoders 113 is ready to play back each of image files, management sever 11 request image decoding start order and display delay time for decoded images to relay transmitter 12. By this, even though decoding of each of image files at image decoders 13 starts by image decoding start order, the decoded images may be played back on all the displays after delayed time.

The management sever 11 may collect and estimate the time between decoding start by image decoders and image output. The management server 11 may determines delay time considering the estimated time lapse.

For this, the management server 11 may further comprise clock synchronizer 115 which enables the clock of image decoders 13 to synchronize with the clock of management server 11.

The multiple image files are data files for divided images constituting one image having ultra high resolution. Each of image file may be, for example, HD standard image file having 1920×1080 high resolutions. Each of image files may have same resolutions. But depending upon resolution of displays 14, the image files may not have the same resolutions. Further, divided images may be seamless, but the images may be separated by virtue of the frame of display device.

The relay transmitter 12 receives data of image files in order or simultaneously, and relays the received data to corresponding image decoders 13 in order or simultaneously. The relay transmitter 12 may be connected to the management server 11 through network.

For example, image file A, B, C is divided into A1, A2, A3, . . . , B1, B2, B3, . . . , C1, C2, C3, . . . , respectively, and the management server 11 may transmit the divided data segment to the relay transmitter 12 in order such as A1, B1, C1, A2, B2, C2, A3, B3, C3, . . . . The relay transmitter 12 relays A1, A2, A3, . . . to corresponding image decoder A. B1, B2, B3, . . . are relayed to its corresponding image decoder B; C1, c2, C3 . . . to image decoder C.

In accordance with one embodiment of the present invention, relay transmitter 12 reconstructs the received data segments to form original image file and then transmit the file to each of image decoders.

According to one embodiment of the present invention, the relay transmitter 12 has wire or wireless communication output port for multiple image decoders 13. Data can be transmitted via the ports.

The relay transmitter 12 receives decoding start order and delay order from the management server 11, and broadcast the orders to multiple image decoders 13.

Image decoders 13 decode the received image files to display the image on display devices. Even though the image decoder 13 starts decoding process in accordance with the decoding start order from the management server 11, it does not display decoded images immediately on the display devices. Rather, it starts displaying the decoded image when the delay time lapses in accordance with the display delay order transmitted with decoding start order.

Even though each of multiple decoders 13 starts decoding process same time, it is still possible that there is time difference for each decoded images to start display. By this, each images displayed on each display devices 14 may not be synchronized with each other. The system for playing back images using multiple display devices according to the present invention does not use such complicated algorithm in synchronizing multiple images for multiple display images, but use delay time for multiple images to display from receiving, resulting in making multiple images be synchronized

For example, three decoders A, B, C may start decoding process by decoding order from management server 11 through relay transmitter 12. After decoding process, decoder A, B, C start output decoded images after 30 ms, 50 ms, 80 ms, respectively. In this case, even though three decoding process start simultaneously, three displayed images are not synchronized with each order because of time for decoding process.

To resolve this problem, management server 11 of the present invention sets 100 ms as delay time for decoded images to output, and three decoded images start displaying after 100 ms from start of decoding.

The image decoder 13 may provide management server 11 with estimates for time between decoding-start and output of decoded images.

For more accurate image synchronization, image decoders 13 may allow its clock to be synchronized with the clock of management server 11 through clock synchronizer 114.

Multiple display devices 14 may be arranged in two dimensionally rectangular pattern, such as 2×2, 4×2. Or they can be arranged in any patter for users to get desired image effect.

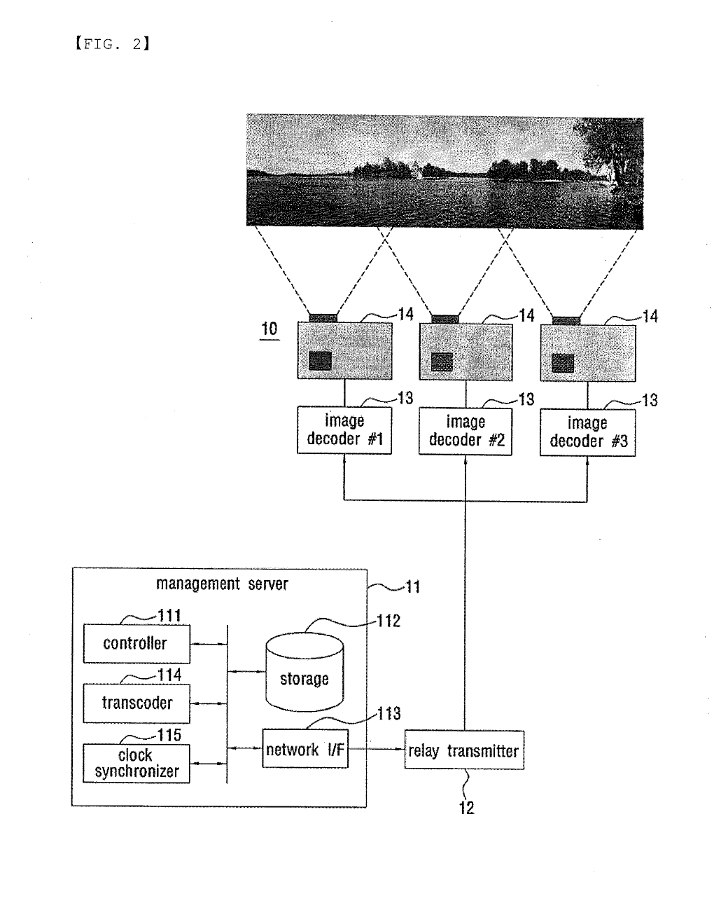

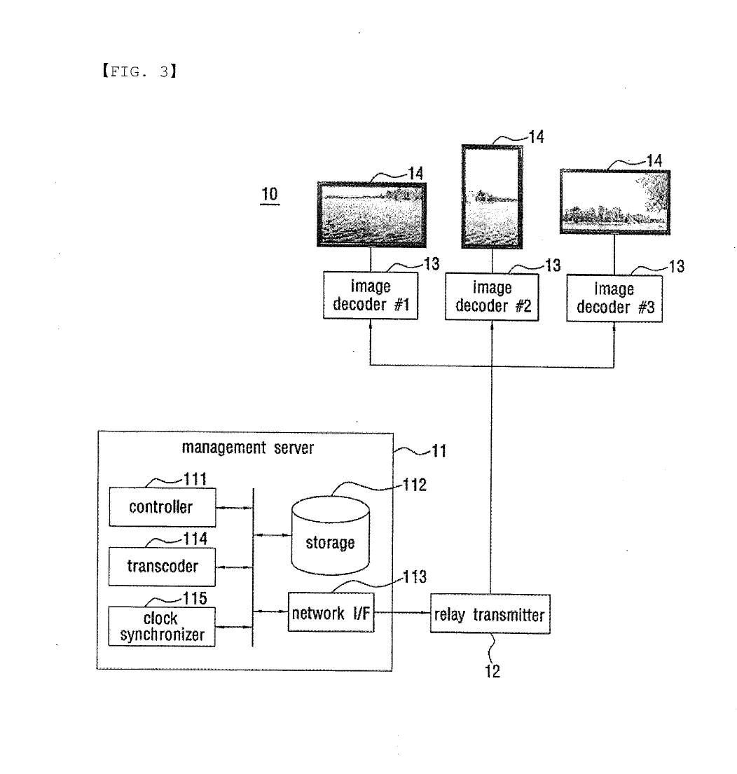

FIG. 2 is a conceptual drawing for the system of the present invention using multiple display devices arranged in orderly manner. FIG. 3 is another conceptual drawing for the system of the present invention using multiple display devices arranged in random manner.

Referring to FIG. 2, one image is seamlessly divided into three images, and they output on three display devices arranged closely.

Referring to FIG. 3, one image is seamlessly divided into three images, but they output on three display devices arranged apart from each other.

Management server 11 transmits three image files to relay transmitter 12 respectively, and transmits decoding start order and display delay time to each of multiple image decoders 13 through the relay transmitter 12. The relay transmitter 12 relays the decoding start order and display delay time to each of image decoders 13. Image decoders 13 start decoding process simultaneously, and output the decoded images after delay time set in the display delay order lapses.

1. A system for playback of ultra high resolution video using multiple displays, comprising multiple image decoders for decoding each of multiple image files to provide the decoded images to each of multiple displays; management server to provide multiple image files; and relay transmitter to receive the multiple image files from the management server and then distribute the multiple image files to corresponding multiple decoders, wherein the relay transmitter receives display delay time and decoding order for the image files from the management server, and broadcasts the relay time and decoding start order to the multiple image decoders, and each of multiple image decoders decodes corresponding image file in accordance with the decoding start order, respectively, and provides the decoded image to each of multiple displays after delay time.

2. The system for playback of ultra high resolution video using multiple displays according to claim 1, wherein the management server sets image decoders as destination which plays back each of image files, and transmit data of multiple image files to the relay transmitter, or transmits divided image files with the time range, frame, picture or data size simultaneously.

3. The system for playback of ultra high resolution video using multiple displays according to claim 1, wherein the image decoder estimates and provides to the management server the time between the decoding started and the decoded image output, and the management server determines the display delay time based upon the time lapse from the image decoders.

4. The system for playback of ultra high resolution video using multiple displays according to claim 1, wherein the multiple displays are arranged to form m×n (m and n are integers >1) rectangular matrix.

5. The system for playback of ultra high resolution video using multiple displays according to claim 1 according to claim 1, wherein multiple displays are arranged in random pattern.
